(19) United States
(12) Patent Application Publication
(10) Pub. No.: US 2026/0295989 A1
(43) Pub. Date: Oct. 1, 2026

(54) Composite Material of Multilayer Metal Sandwiching Graphene or Graphene Composite and Manufacturing Method of the Same

(71) Applicant: Jeng-Shyong WU, Hsinchu City (TW)

(72) Inventor: Jeng-Shyong WU, Hsinchu City (TW)

(21) Appl. No.: 19/363,756

(22) Filed: Oct. 21, 2025

(30) Foreign Application Priority Data
Mar. 31, 2025 (TW) 114112372

(51) Int. Cl. B32B 38/00; B32B 1/08; B32B 3/26; B32B 5/16; B32B 9/00; B32B 9/04; B32B 37/00; B32B 37/10

(52) U.S. Cl. CPC B32B 38/0036; B32B 1/08; B32B 3/26; B32B 5/16; B32B 9/007; B32B 9/041; B32B 37/0084; B32B 37/10; B32B 38/0012; B32B 2038/0028; B32B 2250/40; B32B 2264/108; B32B 2307/202; B32B 2309/02; B32B 2310/028; B32B 2597/00

(57) ABSTRACT

A composite material of multilayer metal sandwiching graphene or graphene composite and manufacturing method of the same. The composite material including a core base and multi filler parts surrounding the core base in an annular manner. The core base is circular in cross-section, linear in shape, and made of metal. The filler part may consist of a single metal layer or multiple metal layers, and a surface on the inner side of the filler part is sandwiched with graphene or a graphene composite. Through a predetermined processing method, processing steps, processing parameters, and procedures such as drawing and compression, the graphene or graphene composite is uniformly sandwiched and fixed between the core base and the filler part. The resulting composite material exhibits tight bonding between each layer with minimal gaps nearly seamless. The bonding interfaces between layers may exhibit identical or different fusion states, thereby providing the desired electrical or physical properties suitable for use in various electronic devices.

### BACKGROUND OF THE INVENTION

### Field of the Invention

The present invention relates to a composite material, more particularly to a composite material comprising a metallic core base having a circular cross-section and linear shape, which is annularly covered by multilayer of metallic filler parts. The inner surface of each filler part is formed with graphene or a graphene composite, thereby forming a composite material of multilayer metal sandwiching graphene or graphene composite, as well as a manufacturing method of the same.

### Description of the Prior Art

In recent years, the application of graphene or graphene composites has become extremely widespread. Research and development, applications, and related commercial products involving graphene or graphene composites have been extensively disclosed.

The following table shows the electrical and physical properties of various materials.

| | | | Tensile | Young's |
|---|---|---|---|---|
| | Conductivity | Density | Strength | Modulus |
| Material | (W/m * k) | (g/cm³) | (MPa) | (GPa) |
| Tin (Sn) | 67 | 7.3 | 15-200 | 47 |
| Nickel (Ni) | 91 | 8.908 | 140-195 | 170 |
| Aluminum (Al) | 210 | 2.71 | 40-50 | 70 |
| Brass | 115 | 8.5 | 550 | 97 |
| Copper (Cu) | 398 | 8.94 | 220 | 130 |
| Gold (Au) | 315 | 19.32 | 100 | 79 |
| Silver (Ag) | 428 | 10.49 | 170 | 83 |
| Diamond | 2500 | 3.51 | 60000 | 1050 |
| Graphite | 300-1500 | 1.3-1.95 | 6.9-100 | 8-15 |
| Graphene | 5020 | 0.215 | 130000 | 1000 |
| (theoretical) | | | | |

From the above table, it is evident that graphene exhibits superior characteristics compared to other materials and is thus applicable in various fields. However, the values listed for graphene in the table are theoretical, and achieving such values in practice is nearly impossible.

Graphene is a newly developed material and has become a popular and promising product in recent years, with inevitable competition among different approaches. Various methods for forming graphene on materials have respective advantages and disadvantages. Some methods involve depositing graphene on foamed metals, while others deposit graphene on an additional metal layer. Such layering typically requires the use of Chemical Vapor Deposition (CVD). However, the use of specialized metal foam base material combined with CVD results in a complex and challenging manufacturing process with inherent disadvantages.

Examples of related prior art as follows:
TWI636954 discloses graphene dispersions and their preparation methods.
CN104862512 discloses “copper-based graphene composite materials” or their semi-finished products “copper alloy graphene composite powders.”
CN108193065 discloses spraying graphene suspension onto copper, followed by drying, cold rolling, and annealing.
CN103952588 discloses processing methods such as ultrasonic dispersion and related semi-finished or finished products. In particular, ultrasonic dispersion power of 100 W-1000 W is commonly known and applied.
CN105624445 discloses a mixture of graphene, nano copper powder, and nano cobalt powder; the mixture is added to anhydrous ethanol and physically dispersed into a slurry; the slurry is then ball milled into powder, followed by drying and annealing.
TWI622663 and TWI682848 both relate to “graphene metal composites,” formed by depositing graphene on porous metal foam base material, which are then compressed to form graphene metal composites. Both employ deposition methods followed by compression. The composite produced by the deposition method must be compressed into a usable finished product, however, whether the compression alone is sufficient to fix the graphene to achieve the desired functional properties remains uncertain.
TWI535653 discloses processing slurry using Atmosphere Plasma Pressure Jet (APPJ) equipment, which is general known technology.

The above prior art generally involves alternately layering copper sheets or foils in planar form, sandwiching graphene, and then pressing to uniformly distribute the graphene within the copper material, resulting in graphene-copper composites with enhanced properties. However, achieving uniform dispersion of graphene remains a significant challenge.

Upon reviewing the current graphene materials or graphene composites, including scientific literature, patent publications, and related commercial products, it is evident that none have achieved the desired or ideal performance. In view of this, the inventors have actively pursued improvements and, after numerous tests and developments, have successfully created the present invention: a composite material comprising multilayer metal sandwiching graphene or a graphene composite and a method for manufacturing the same.

### SUMMARY OF THE INVENTION

Accordingly, the present invention is objected to provide a composite material of multilayer metal sandwithing graphene or graphene composite and a manufacturing method of the same. The invention is based on the applicant's earlier Taiwan Patent TWI658472, titled “An Electrical Conductor Combined with a Composite Conductor,” and further improves upon it by sandwiching, initially positioning, and shaping graphene, followed by subsequent processing steps to reshape, fix, form, and stabilize the graphene. The resulting products may be manufactured in various specifications to exhibit comprehensive and effective performance suitable for application.

According to the composite material of multilayer metal sandwithing graphene or a graphene composite and a method for manufacturing the same of the present invention, wherein the graphene or graphene composite is stably sandwiched between multiple metal layers. Through shaping, positioning, and orientation steps, the graphene is fixed in place without being affected by external factors, thereby allowing it to exhibit its intended performance and combined properties. In addition to cylindrical and linear shapes, the final products may also be processed into various other forms for diverse applications.

According to the composite material of multilayer metal sandwithing graphene or a graphene composite and a method for manufacturing the same of the present invention, in which the graphene is sandwiched between multiple metal layers, ensuring its stability, protection from exposure, and secure positioning, shaping, and orientation. This enables the graphene to exert its full functional capabilities and ensures long-term and stable use.

According to the composite material of multilayer metal sandwithing graphene or a graphene composite and a method for manufacturing the same of the present invention, in which the graphene is maintained in a stable, solid, strong, and durable state, preserving its optimal form and position. This prevents displacement, deformation, or agglomeration that would otherwise impair its conductivity and other performance characteristics, thus allowing it to deliver its intended functionality.

As for the composite material of multilayer metal sandwithing graphene or a graphene composite and a method for manufacturing the same of the present invention, its detailed structure and specific embodiments can be fully understood with reference to the following descriptions made in accordance with the accompanying drawings.

### BRIEF DESCRIPTION OF THE DRAWINGS

FIG. 1 is a schematic cross-sectional view of the composite material of multilayer metal sandwiching graphene or a graphene composite of the present invention;

FIG. 2 is an enlarged structural view of the graphene used in the composite material of the present invention;

FIG. 3 is a schematic cross-sectional view of the metallic core base and the first filler part in the composite material of the present invention;

FIG. 4 is a schematic cross-sectional view showing the addition of a second filler part to the composite material shown in FIG. 3;

FIG. 5 is a schematic cross-sectional view showing the addition of a third filler part to the composite material shown in FIG. 4;

FIGS. 6a to 6e are schematic diagrams illustrating the process steps for manufacturing the composite material shown in FIG. 3;

FIG. 6f is a top cross-sectional view of the base material and the filler part shown in FIG. 6a;

FIGS. 7a to 7e are schematic diagrams illustrating the process steps for manufacturing the composite material shown in FIG. 4;

FIG. 7f is a top cross-sectional view of the base material and the filler part shown in FIG. 7a;

FIGS. 8a to 8e are schematic diagrams illustrating the process steps for manufacturing the composite material shown in FIG. 5;

FIG. 8f is a top cross-sectional view of the base material and the filler part shown in FIG. 8a;

FIG. 9 is a schematic cross-sectional view of the drawing and pressing device (die) used in the manufacturing method of the present invention, including various cross-sectional views;

FIGS. 10a to 10c are schematic diagrams showing the shape transformation of the graphene or graphene composite during the manufacturing process.

### DETAILED DESCRIPTION OF PREFERRED EMBODIMENT

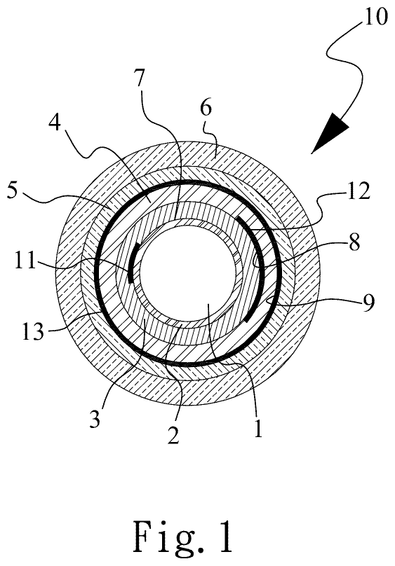

As shown in FIG. 1, the composition material of multilayer metal sandwiching graphene or a graphene composite of the present invention comprises a composite material 10, which includes: a metallic core base 1 disposed at the innermost layer and formed as an elongated linear body; a first filler part 2 in an annular form covering the metallic core base 1, which may also serve as a base material in other applications; a second filler part 3 in an annular form covering the first filler part 2; a third filler part 4 in an annular form covering the seocond filler part 3; a fourth filler part 5 in an annular form covering the third filler part 4; and an outermost filler part 6 in an annular form covering the fourth filler part 5.

A second interface 7 is formed between the inner surface of the second filler part3 and the outer surface of the first filler part2, and this second interface 7 sandwichs a graphene or graphene composite 11. A third interface 8 is formed between the inner surface of the third filler part 4 and the outer surface of the second filler part3, and this third interface 8 sandwichs a graphene or graphene composite 12. A fourth interface 9 is formed between the inner surface of the fourth filler part 5 and the outer surface of the third filler part 4, and this fourth interface 9 sandwichs a graphene or graphene composite 13. The outermost filler part 6 may or may not contain graphene or a graphene composite and may serve as a protective layer or reinforcement layer for the conductor properties of the composite material. The graphene or graphene composites 11, 12, and 13 at the interfaces 7, 8, and 9 may be of the same or different coverage areas or shapes, or may be formed from combinations or compositions of graphene or graphene composites. The uniformity in the axial extension forming the elongated linear body enables current-like flow during use, thereby enhancing current conduction or other functions by leveraging the properties of graphene.

The graphene or graphene composites used in the multilayer metal composite material of the present invention may be:
m Graphene powder: The number of graphene layers may range from 1 to 10 and may include single-layer or multi-layer mixtures;
A dry mixture of graphene and fine metal powder;
A graphene solution, suspension, or mixture, such as ink, coating, or conductive ink; additive liquids may include water, alcohol, dispersions, suspensions, adhesives, or other organic compounds;
a Graphene-metal composites in solid form or as foil.

The graphene or graphene composites used in the multilayer metal composite material of the present invention, graphene is first formed on the inner surface of filler part before the composite material is drawn and compressed. The various filling devices, heating devices, and ultrasonic (or high-frequency) devices are configured as follows:
(1) Graphene:
Filling device: automatic quantitative feeder;
Heating device: capable of removing moisture; temperature set at 200° C.;
Ultrasonic (high-frequency) device: adjustable frequency between 100-1000 Hz.
(2) Graphene and fine metal powder mixture: dry powder;
Filling device: automatic quantitative feeder;
Heating device: capable of removing moisture; temperature set at 200° C.;
Ultrasonic (high-frequency) device: adjustable frequency between 100-1000 Hz.
(3) Graphene suspension mixture (coatings, inks, or pastes):
Additives: water, alcohol, dispersants, suspensions, adhesives, or organic compounds;
Equipment and methods:
Filling devices: for less viscous mixtures, general spraying, electrostatic spraying, or printing may be used; for more viscous mixtures, brushing, coating, or printing may be used;
Heating device: used for decomposing and evaporating additives;
temperature set between 500° C.-1000° C. Atmospheric Plasma Pressure Jet (APPJ) heating devices may be used;
Ultrasonic (high-frequency) device: adjustable frequency between 100-1000 Hz.
(4) Graphene metal composite: may be solid or in foil form.
(5) Graphene copper composite: may be fixed onto the filler part by spot welding.

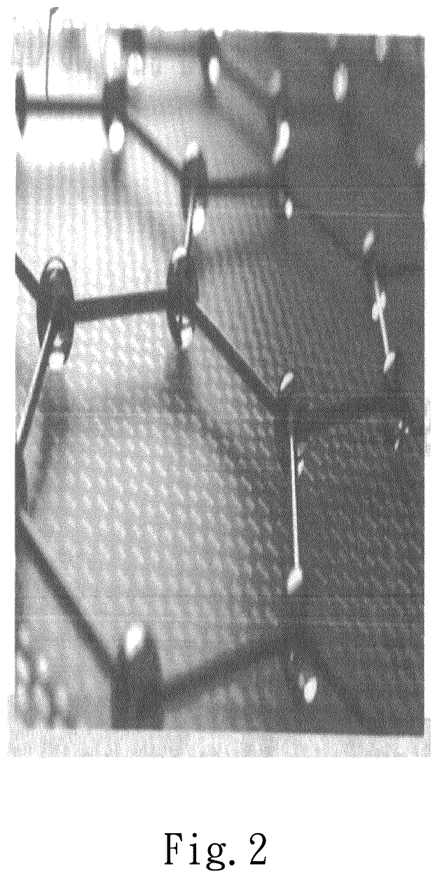

Please refer to FIG. 2, which is an enlarged schematic view showing the graphene structure used in the multilayer metal composite material of the present invention.

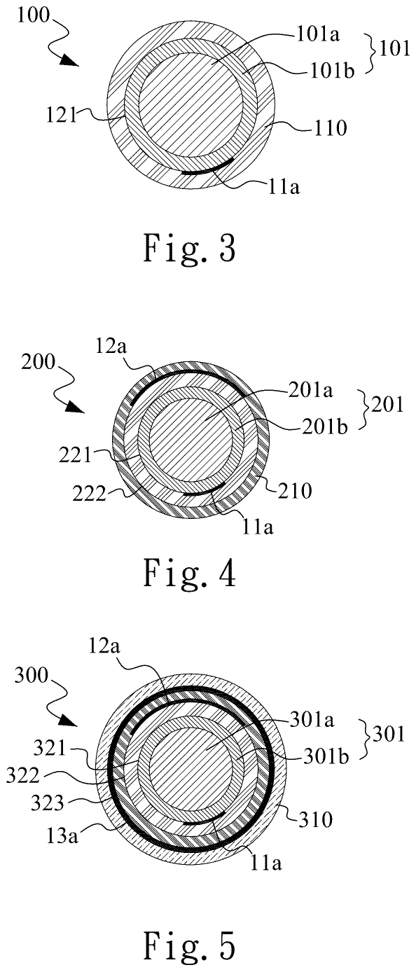

Please refer to FIG. 3. The composite material of multilayer metal-sandwiched graphene or graphene composite of the present invention, wherein the composite material is a first composite electrical conductor 100, which includes a metallic core base 101 and a first filler part 110. The metallic core base 101 comprises an inner layer base material 101a and an outer layer base material 101b, which may be of the same or different materials. The inner surface of the first layer filler part 110 forms a graphene or graphene composite 11a. The first layer filler part 110 is entirely wrapped around the metallic core base 101 as its axis, thereby forming an interface 121 therebetween. Although gaps may remain at the contact interfaces, extrusion and drawing using a die mold can render the interface nearly seamless, and further compression processing may be applied until the predetermined outer diameter is achieved.

Accordingly, the graphene or graphene composite of the first composite electrical conductor 100, and the graphene or graphene composite 11a of the first filler part110, essentially represent descriptions of the components in sequence, respectively indicating different functional roles, though they are fundamentally consistent in nature. The graphene or graphene composite 11 is sandwiched between the outer surface of the metallic core base 101 and the inner surface of the first filler part 110. Its width is not restricted, and it extends longitudinally along the circular layers.

Please refer to FIG. 4, which illustrates a second composite electrical conductor 200 comprising a second base material 201 and a second filler part 210. The inner surface of the second filler part 210 forms a graphene or graphene composite 12a. The second base material 201 is derived from the first composite electrical conductor after undergoing extrusion and drawing processes, and therefore includes an inner layer base material 201a and an outer layer base material 201b after said processing, and retains the first interface 221 and the graphene or graphene composite 11a. In comparison to FIG. 3, this embodiment includes an additional second filler part 210, whose inner surface is coated with a graphene or graphene composite 12a. The second filler part 210 completely surrounds the second base material 201 concentrically, forming a second interface 222 therebetween. Although gaps may exist at the contact surfaces, extrusion and drawing through a die mold can render the interface nearly seamless, and further compression processing may be applied until the predetermined outer diameter is achieved.

Thus, the first composite electrical conductor 100 and the second composite electrical conductor 200 respectively represent the conductor before and after drawing. Likewise, the first filler part 110 and the second filler part 210 are merely descriptions of functionally equivalent components at different processing stages. The graphene or graphene composite 12a is sandwiched between the outer surface of the second base material 201 and the inner surface of the second filler part210. Its width is not limited; in this embodiment, it is shown to be wider than the graphene or graphene composite 11a in FIG. 3. These two graphene or graphene composites 11a and 12a may be positioned at the same or different angular positions; as illustrated, they are placed diametrically opposite each other.

Please refer to FIG. 5, which illustrates a third composite electrical conductor 300, comprising a third base material 301 and a third filler part 310. The inner surface of the third filler part 310 forms a graphene or graphene composite 13a. As shown, the third base material 301 is derived from the second electrical composite conductor after undergoing a further round of extrusion and drawing, thus comprises an inner layer base material 301a and an outer layer base material 301b that have undergone said further processing, and retains the first interface 321, second interface 322, and the graphene or graphene composites 11a and 12a. In comparison to FIG. 4, this embodiment further includes a third layer filler part 310 whose inner surface carries a graphene or graphene composite 13a. The third layer filler part 310 concentrically and completely surrounds the third base material 301, forming a third interface 323. Although gaps may exist at the contact surface, extrusion and drawing through a die mold can render the interface nearly seamless, and further compression processing may be applied until the predetermined outer diameter is achieved.

Broadly speaking, the composite electrical conductors shown in FIGS. 3, 4, and 5, namely, the first composite electrical conductor 100, the second electrical composite conductor 200, and the third electrical composite conductor 300, respectively represent electrical conductor formed by the combinations of composite conductive materials at each stage. The metallic core base 101, the second base material 201, and the third base material 301 may be composed of identical or different materials. The first, second, and third filler parts 110, 210, and 310, each respectively have a graphene or graphene composite 11a, 12a, and 13a formed on their inner surfaces.

As shown in FIGS. 3, 4, and 5, although the metallic core base 101, the second base material 201, and the third baes material 301 all have the same structure material as the base material, repeated extrusion and drawing processes result in progressive reductions in outer diameter or area, such that the metallic core base 101>the second base material 201>the third base material 301 in size.

Similarly, as shown in FIGS. 3, 4, and 5, although the first, second, and third filler parts 110, 210, and 310 all represent the outer layer filler parts, repeated extrusion and drawing process result in progressive reductions in outer diameter or area, such that first filler part 110>second filler part 210>third filler part 310 in size.

Likewise, as shown in FIGS. 4 and 5, the second and third filler parts 210 and 310 are progressively reduced in diameter or area due to multiple rounds of extrusion and drawing, such that second filler part 210>third filler part 310 in size.

In the present invention, as shown in FIGS. 3 to 5, the various interfaces 121, 221, 222, 321, 322, and 320 formed between adjacent layers may vary in structure, composition, or state, such as mixtures, crystals, alloys, or other forms, depending on the materials used and the processing methods, sequences, and parameters of the adjacent layers. These interfaces may exert the same or different current effects on the usage-setting device. Among them, the graphene or graphene composite 13a is sandwiched between the outer surface of the third base material 301 and the inner surface of the third filler part 310, and nearly fills the entire gap between the two layers.

The following describes in detail the manufacturing process of the multilayer metal-sandwiched graphene or graphene composite material of the present invention, as well as its potential performance benefits and applications.

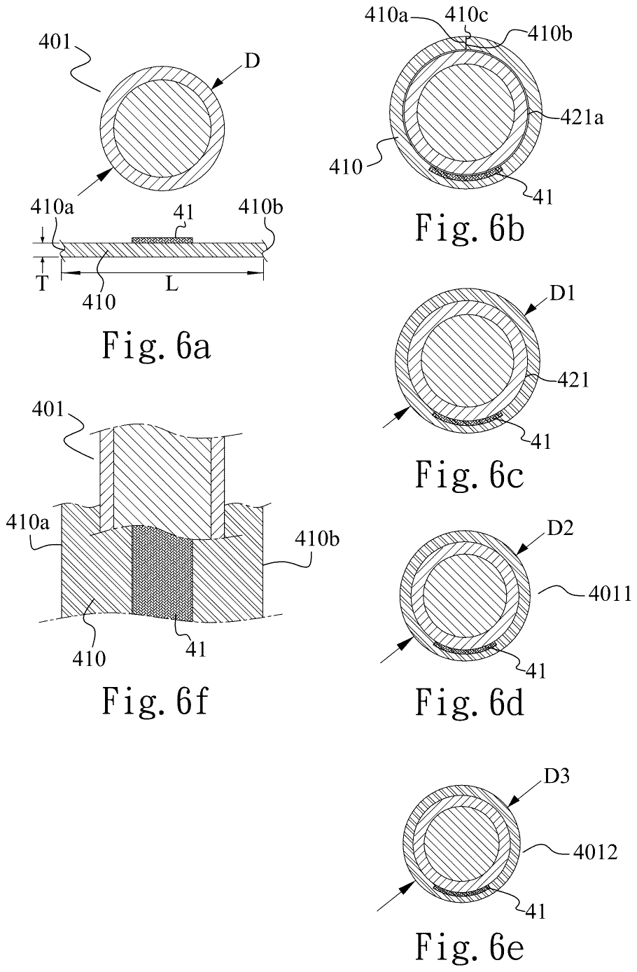

Please refer to FIGS. 6a to 6f, which illustrate the manufacturing process of the multilayer metal sandwiching graphene or graphene composite material according to the present invention. As shown in FIG. 6a, a core base 401 is a long rod-shaped body with an undefined length and an outer diameter D. The core base 401 may be a monolithic or composite structure, conductive or non-conductive, but must possess properties suitable for compression and extension.

A first filler part 410 is a strip-shaped electrical conductor, with its inner surface formed with graphene or a graphene composite 41. Its length is not limited. The width L is determined according to the outer diameter or perimeter of the core base 401, and the thickness T is determined according to the preset content ratio of the various materials, but in principle, it must not exceed the range suitable for processing. The core base 401 may be annularly wrapped by the first filler part 410 (whose inner surface forms the graphene or graphene composite 41) with its two end portions 410a and 410b.

As shown in FIG. 6b, the two end portions 410a, 410b of the first filler part 410 (having graphene or a graphene composite 41 on the inner surface) are wrapped inwardly to axially extend and completely cover the core base 401. Then the two end portions 410a, 410b of the first filler part 410 are joined together. The gap 410c between the two end portions 410a, 410b may be connected completely through welding. At this point, a gap 421a exists between the core base 401 and the first filler part 410.

After welding, the core base 401 and the first filler part 410 are further compressed by a die mold. As shown in FIG. 6c, the gap 421a between the core base 401 and the first filler part 410 nearly disappears, forming an annular interface 421. The gap 410c between the two end portions 410a, 410b of the first filler part 410 also almost disappears. The resulting diameter D1 is less than D+2T.

Once the end portions 410a, 410b of the first filler part 410, the gap 410c, and the gap 421a have all disappeared, the material is continuously compressed and extended or heated and annealed using the die mold to reach a preset outer diameter D1. The preset outer diameter D1 may be defined as equal to the original outer diameter D of the core base 401 plus twice the thickness 2T of the first filler part 410. After ensuring that the gap 421a has fully disappeared, the material is further compressed and extended or heated and annealed by the die mold to reach a preset outer diameter D2 (as shown in FIG. 6d), becoming the first composite material 4011. Then, as shown in FIG. 6e, the first composite material 4011 is drawn and compressed to reduce the wire diameter to a preset outer diameter D3 of the specification, forming the first composite electrical conductor 4012.

Please refer to FIG. 6f, which illustrates that the inner surface of the first filler part 410 forms graphene or a graphene composite 41. The two end portions 410a, 410b of the first filler part 410 are positioned for circumferential wrapping of the first base material 401, so that the graphene or graphene composite 41 is sandwiched between the outer surface layer of the first base material 401 and the inner surface layer of the first filler part 410.

The content and ratio of each of the materials described above may be determined based on the required quantity of each material. The compression ratios in processing generally do not affect the preset content and ratio of each material.

The use of the aforementioned materials depends on the functional requirements of the intended device. Through the differences in types, properties, composition, quantity, etc. of the materials used, various characteristics are produced depending on the overall components during current flow, thereby enabling the intended application in a specific device.

As shown in FIG. 6d, the first composite material 4011 is the product formed after the thickness T of the first filler part 410 has been reduced through drawing die mold processing. As shown in FIG. 6e, the first composite electrical conductor 4012 is the conductor formed by further reduction of the first composite material 4011. In FIG. 6e, reference symbol D3 indicates the reduced outer diameter corresponding to the preset wire diameter.

As shown in FIGS. 6a to 6f, during the process of manufacturing the electrical conductor made of composite materials according to the present invention, interfaces with identical or different properties may be formed between contact surfaces of the same or different materials. These may include mixed bodies, crystals, alloys, oxides, etc. During current flow, various current effects such as skin effect, eddy current, ring current, or magnetic effect, thermal effect, crowding effect, or combined effects of the above may be generated. This allows for application in intended devices to produce special effects and uses.

In particular, when the graphene or graphene composite is sandwiched between metals and then experiencing longitudinal drawing and compression, the graphene or graphene composite can be more uniformly and stably formed between the metal conductors, thereby avoiding undesirable issues such as graphene agglomeration.

Accordingly, the process illustrated in FIGS. 6a to 6e may be used to produce the conductive composite material shown in FIG. 3.

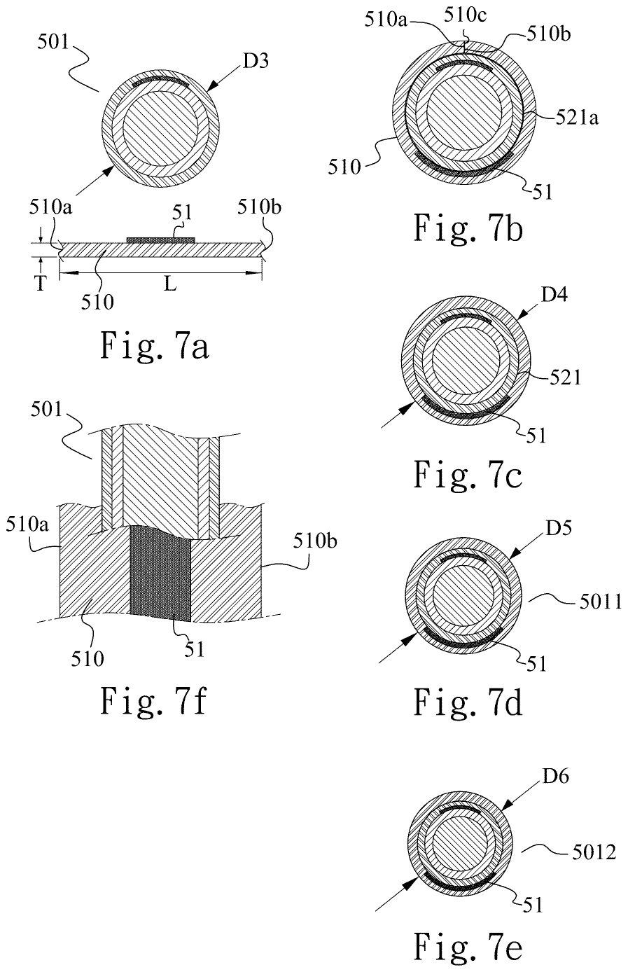

The processing procedure illustrated in FIGS. 7a to 7f may be used to produce the conductive composite material shown in FIG. 4.

FIGS. 7a to 7e show the following: a second core base 501, which serves as the base material prior to the second addition and is equivalent to the first composite material 4011; a second filler part 510, having two end portions 510a and 510b; a gap 521a between the second filler part 510 and the second core base 501; and a pre-drawing and compression gap 510e between the front end portion 501a and end portion 510b; interface 521 after compression and drawing; the second composite material 5011; the second composite electrical conductor 5012.

FIG. 7f is a sectional side view corresponding to FIG. 7a, illustrating that the inner surface of the second filler part 510 is formed with graphene or a graphene composite 51. The two end portions 510a and 510b of the filler part are positioned for circumferential wrapping of the second core base 501, such that the graphene or graphene composite 51 is sandwiched between the outer surface of the second core base 501 and the inner surface of the second filler part 510. Additionally, the widths of the graphene or graphene composites 41 and 51 shown in FIGS. 6a and 7a, respectively, differ; the graphene or graphene composite 51 is wider than 41 and is positioned directly opposite to graphene or graphene composite 41, forming a 180-degree angle between the two. The amount, width, thickness, and angular orientation of the added graphene may be adjusted according to design requirements. These two layers of graphene or graphene composites 41 and 51, each sandwiched between different layers of metal, can undergo longitudinal drawing and compression to ensure even and stable placement between the metal layers, avoiding issues such as graphene agglomeration and further enhancing its performance characteristics.

Through the same processes as shown in FIGS. 6a-6f, interfaces of identical or different properties are formed at the contact surfaces between materials of the same or different types. Moreover, the interface 521 formed between the second filler part 510 and the second core base 501 is subjected to secondary processing step, which either preserves the original interface structure or results in various interface structures under different conditions. Thus, through the die mold process steps shown in FIGS. 7a to 7e, two layers with either identical or different interfaces are formed. When current is applied during operation, a greater variety of identical, different, or combined electrical effects may be generated, thereby producing special functional effects in the intended application.

As shown in FIG. 7c., the second core base 501 and second filler part 510 achieve a diameter D4 after compression and drawing via a die mold. As shown in FIG. 7d, the second composite material 5011 achieves a diameter D5 after compression and drawing via a die mold; and as shown in FIG. 7e, the second composite electrical conductor 5012 achieves a diameter D6 after compression and drawing via a die mold.

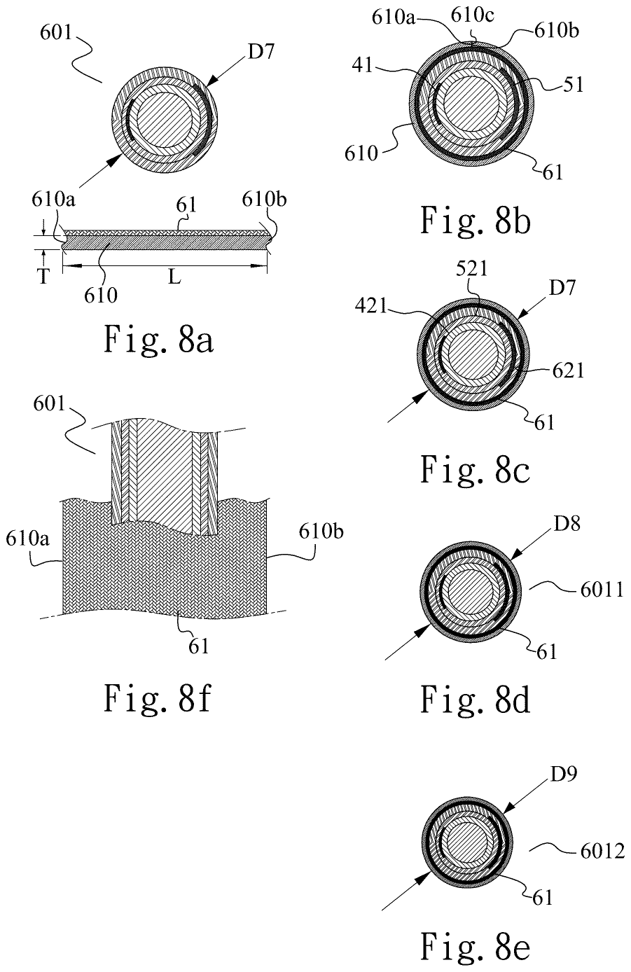

Similarly, the manufacturing process illustrated in FIGS. 8a to 8f is used to produce the composite electrical conductor shown in FIG. 5.

As shown in FIGS. 8a to 8f, which includes: a third core base 601, which serves as the matrix prior to the third addition and is equivalent to the second composite material 5011; a third filler part 610, the surface of which is fully covered with graphene or a graphene composite 61. The two end portions 610a and 610b of the filler part are positioned for circumferential wrapping of the third core base 601, so as to sandwich the graphene or graphene composite 61 annularly between the outer surface of the third core base 601 and the inner arcuate surface of the third filler part 610. In principle, the graphene or graphene composite 61 nearly completely fills the space between the concave outer surfaces of the two metal layers. Following the above stages, three types of graphene or graphene composites are formed, each sandwiched between different layers of metal. As shown in FIGS. 8a-8b-8c-8d-8e, the wire diameter gradually decreases, allowing conductors of various diameters to be used for different applications. Furthermore, at each position, the three types of graphene or graphene composites are uniformly shaped and stably fixed between their respective metal layers, effectively preventing graphene agglomeration and thereby maximizing their performance and exhibiting significantly enhanced properties.

After die compression and drawing, the third core base 601 and third filler part 610 shown in FIG. 8c attain a diameter D7; the third composite material 6011 in FIG. 8d attains a diameter D8; and the third composite electrical conductor 6012 in FIG. 8e attains a diameter D9.

As described above, during the longitudinal compression process by a die mold, interfaces with identical or differing properties, namely, interfaces 421, 521, and 621, are formed at contact surfaces between materials of the same or different types. The graphene or graphene composites 41, 51, and 61 are each sandwiched between concave outer layers of different metals. Each metal layer forms an interface with the respective graphene material, resulting in interconnected and interlocked structural states. These multilayer composite effects enable selective use of different stage products based on their properties, providing the most suitable and advantageous performance for various applications.

It is worth noting that, through multi-layer filler prat, each post-added core base acquires a unique structure that can be further utilized in a variety of forms. For example:
(A) The first, second, and third filler parts may be further rolled into finer wire diameters, or insulated externally for use as wires or cables with predefined functional characteristics.
(B) The graphene or graphene composites formed respectively between the first, second, and third filler part and the base material may be the same or different in type, amount, and distribution. Their arrangement may be narrow or wide, and the relative angles between the three layers may be the same or different, allowing for diverse design configurations.
(C) The processing steps may also vary, and these design differences affect the functional characteristics during use, thereby enabling the creation of unique properties tailored for specific applications.

Through the above detailed explanation in conjunction with the accompanying figures, the structure and manufacturing method of the present invention have been clearly described. This invention specifically addresses the preservation of the original state of graphene and its stable positioning and shaping, improving the composite structure and preventing issues such as graphene agglomeration. This concretely demonstrates that the invention facilitates the maintenance of graphene integrity and enables effective expression of its composite properties, achieving the goal of novelty and innovation. A more complete explanation of the relationship and interaction between changes in the graphene structure and the structure of the metal materials will be provided in the following sections.

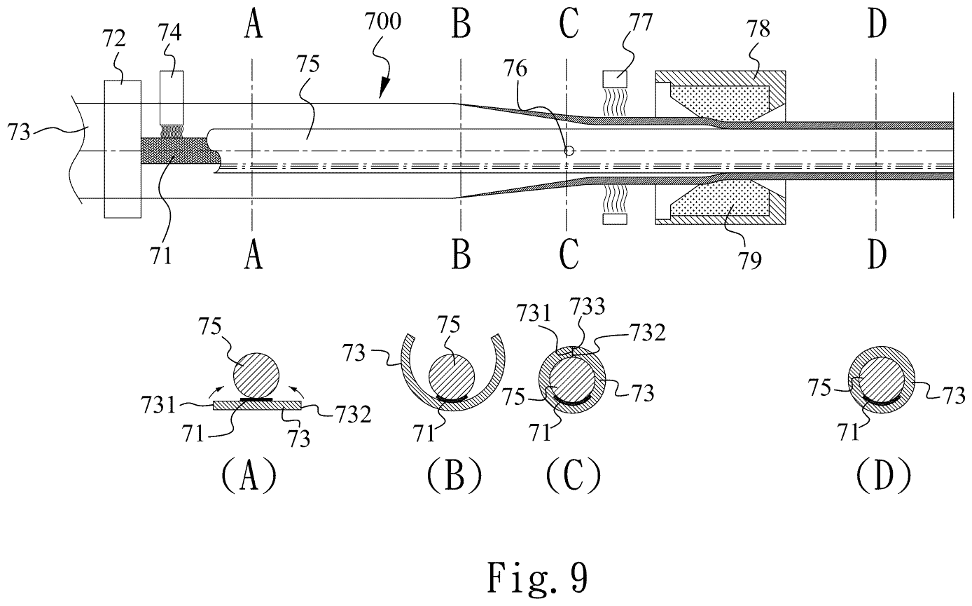

Please refer to FIG. 9. Graphene or a graphene composite 71 is formed on a first filler part 73 via a filling device 72, and then subjected to a heating device 74. The first filler part 73 surrounds the metallic core base 75 at its center. The two side ends 731 and 732 of the first filler part73 bend toward the axial direction of the metallic core base 75 until the ends 731 and 732 are tightly joined, thereby sandwiching and fixing the graphene or graphene composite 71 between the circular outer surface of the metallic core base 75 and the circular inner surface of the first filler part 73.

Then, using a welding device 76, the two side ends 731 and 732 are welded together at the seam to tightly enclose the graphene or graphene composite 71 between the two metallic arc surfaces. If there is a remaining gap, an ultrasonic (high-frequency) device 77 may be applied to disperse the graphene and prevent agglomeration. At this point, the initial structure is completed. It can then be processed through a drawing-compression procedure via a die mold 79 of a drawing-compression device 78, so that the graphene is drawn axially and compressed laterally. The resulting composite material 700 of graphene or graphene composite can be used based on its characteristics or serve as the metallic core base for the next processing stage to fabricate more composite materials of graphene or graphene composite.

FIG. 9 shows the composite material 700 containing graphene or a graphene composite at different processing stages and cross-sections, denoted as diagrams (A), (B), (C), and (D), as detailed below:

FIG. 9(A) is the A-A cross-sectional view showing graphene or a graphene composite 71 formed by filling device 72 and heating device 74. The graphene 71 is sandwiched between the first filler part 73 and the metallic core base 75. FIG. 9(B) is the B-B cross-sectional view showing that after FIG. 9(A) and before the welding step, the side ends 731 and 732 of the filler part 73 wrapping around the graphene 71 and metallic core base 75. FIG. 9(C) is the C-C cross-sectional view showing that after the side ends 731 and 732 of the filler part are brought into close contact, they are welded at the ends by welding device 76 to form weld points 733, thereby temporarily fixing the graphene or graphene composite 71 between the two metal layers. FIG. 9(D) is the D-D cross-sectional view showing that, after welding, the composite material 700 is treated by an ultrasonic (high-frequency) device 77 to disperse and prevent agglomeration of graphene 71. It is then subjected to axial drawing and lateral compression via a die 79 of the drawing-compression device 78 to further shape, fix, and position the graphene 71. The graphene 71 is thus securely sandwiched between the metal layers of the metallic core base and the first filler part 73, making it suitable for use according to its characteristics or as a metallic core base for the next processing stage to form more layered composite materials.

In summary, all kinds of materials and equipment used above can be selected and evaluated appropriately. The following are examples:
1. Graphene: Powder form, 1 to 10 layers, may be used individually or as mixed layers.
Equipment:
   Filling device: Quantitative automatic feeding equipment.
   Heating device: Capable of removing moisture via evaporation; generally operated around 200° C.
   Ultrasonic (high-frequency) device: Adjustable between 100-1000 Hz.
2. Graphene-metal fine powder composites: Dry powder.

### Equipment: Same as Those Used for Item 1 Graphene.

3. Graphene suspensions: Mixtures, such as conductive inks, thermal pastes, or coatings.
   Additives: Water, alcohol, dispersants, suspensions, adhesives, organic compounds, etc.
   Equipment and methods:
      Filling device: For more fluid suspensions—ordinary spraying, electrostatic spraying, or printing; for more viscous suspensions—brushing, coating, or printing; choice depends on concentration.
      Heating device: Should volatilize or decompose additives; usually operated between 500-1000° C. Can also use Atmosphere Plasma Pressure Jet (APPJ).
      Ultrasonic (high-frequency) device: Adjustable between 100-1000 Hz.
4. Graphene-metal composites: In solid or foil form.
Commercially available products may be selected, such as graphene-copper composites, with thickness and width specified according to design requirements. Alternatively, they may be spot-welded to the filler part and sandwiched between metal layers.

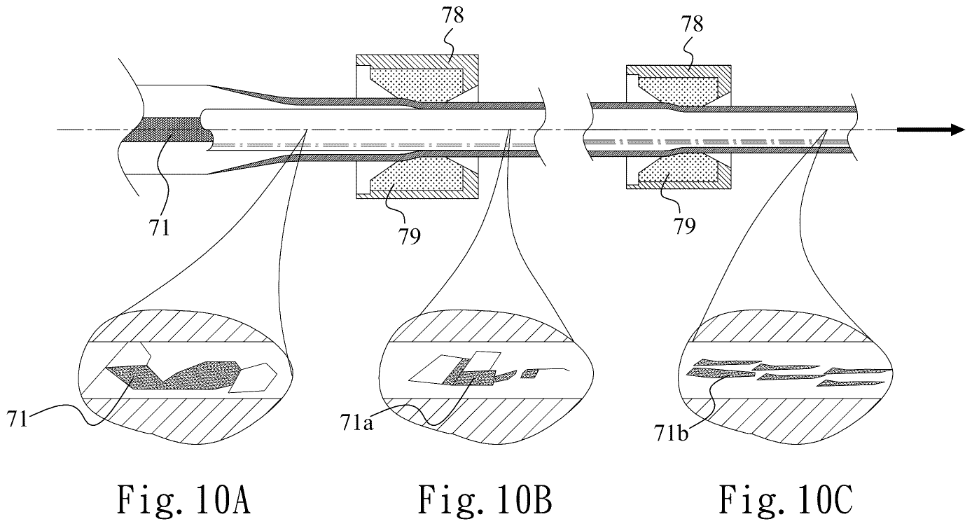

Please refer to FIG. 10A, which shows an enlarged view after the welding step and before drawing-compression. The filled graphene 71 is sandwiched between two layers of metal, namely the first layer filler part 73 and the metallic core base 75. Although sandwiched in place, the graphene 71 still appears disordered with significant gaps, making it prone to agglomeration. This may result in degradation of the desirable electrical and physical properties of the graphene 71.

Next, the composite material 700 passes through an ultrasonic (high-frequency) device 77 to prevent agglomeration. That is, through the die apparatus 79 of the drawing and pressing device 78, the composite material 700 is axially drawn and laterally compressed. At this time, the diameter of the composite material 700 decreases, and its length increases, thereby reducing the gap between the first layer filler part 73 and the metallic core base 75, so that the graphene 71 is more tightly sandwiched. The space is reduced, causing the graphene 71 to transform into graphene 71a and 71b, as shown in FIGS. 10B and 10C, changing from a disordered state to a more ordered and flattened state. This results in a structure as shown in FIG. 3, or alternatively a structure as shown in FIG. 6c. Moreover, the graphene composite material formed in this initial molding process can also continue to be used in the subsequent base material addition processes.

Subsequent drawing and compression procedures may be carried out one or more times, in combination with an annealing process. The combination of drawing/compression and annealing processes is already widely established and mature, thus detailed explanations are unnecessary. Once the scheduled processing steps for the sandwiched graphene are completed, the drawing and compression processes are carried out along the axial direction of the round bar. Variations in the thickness of the metal layer, or the changes in metal crystal grains during the annealing process, will all affect the form of the graphene sandwiched between the metals-its composition density changes, and its arrangement extends in an orderly fashion along the axis. When such composite materials of graphene or graphene composite are used as electric wires, the graphene can fully perform its electricity transmission function. The current transmission path along the axial direction becomes smooth, enhancing conductivity. Compared to the original metal wire, electrical conductivity should be significantly improved, with effectiveness that is self-evident.

The invention, with its diverse structures and versatile manufacturing methods, may also employ “bilayer graphene” as the raw material. By adopting suitable and feasible manufacturing techniques or by sandwiching, positioning, and shaping the bilayer graphene, a high-efficiency next-generation component can be obtained for specialized applications. Based on the various structural forms and multifunctional manufacturing options described above, further research and development may be conducted to clearly define products suitable for “bilayer graphene” or other combined configurations.

In summary, the composite material of multilayer metal sandwiched graphene or graphene composite and its manufacturing method disclosed by this invention indeed offer an unprecedented and innovative structure. This structure has not been seen in any publication, nor is any similar product found on the market. Therefore, its novelty is beyond doubt. In addition, the unique features and functions of this invention are far superior to conventional technologies, and it undoubtedly exhibits inventiveness over the prior art, thereby meeting the requirements for invention patent applications under and is thus submitted for patent application accordingly.

The above are only preferred embodiments of the present invention, and the scope of the present invention can not be limited with this, that is, the simple equivalent changes and modifications made according to the patent scope of the present invention and the contents of the description, should still belong to the scope covered by the patent of the present invention.

What is claimed is:

1. A composite material of multilayer metal sandwiching graphene or graphene composite, comprising:
a metallic core base having a circular cross-section;
at least one metallic filler part having graphene or a graphene composite formed on its inner surface, the filler part annularly wrapping the core base;
wherein the outer surface of the core base and the inner surface of the filler part jointly sandwich and secure the graphene or graphene composite, the filler part being tightly bonded to the core base with gaps nearly seamless.

2. A composite material of multilayer metal sandwiching graphene or graphene composite, comprising:
a metallic core base having a circular cross-section;
at least one metallic filler part is formed with graphene or a graphene composite formed on its inner surface;
The filler part wraps the core base axially inward from the both lateral ends to form an annular covering layer, and the both ends are joined and tightly bonded to construct a structure, therefore the graphene or graphene composite are fixedly sandwiched between the outer surface of the core base and the inner surface of the filler part; the filler part can be multilayered to form a circular elongated structure.

3. The composite material of multilayer metal sandwiching graphene or graphene composite as claimed in claim 2, wherein the said core base is in the shape of an elongated cylindrical rod; the said filler part is in the shape of a strip, the length of which corresponds to the said core base and the width is based on the said core base's diameter, so that its sides can wrap around the said core base.

4. The composite material of multilayer metal sandwiching graphene or graphene composite as claimed in claim 2, wherein the said graphene or graphene composite can be graphene powder, a dry mixture of graphene and fine metal powder, a graphene solution, or a solid or foil-type graphene-metal composite.

5. The composite material of multilayer metal sandwiching graphene or graphene composite as claimed in claim 2, wherein the said graphene or graphene composite is sandwiched between said multiple filler parts, and the type or amount of said graphene used in each part may vary or remain the same.

6. The composite material of multilayer metal sandwiching graphene or graphene composite as claimed in claim 2, wherein the area or patterns of the said graphene or graphene composite formed on the said filler part may be identical or different.

7. The composite material of multilayer metal sandwiching graphene or graphene composite as claimed in claim 2, wherein the said graphene or graphene composite may almost cover the entire inner surface of the said filler part.

8. The composite material of multilayer metal sandwiching graphene or graphene composite as claimed in claim 2, wherein the positional orientation of said graphene or graphene composite in each filler part can be the same or different.

9. The composite material of multilayer metal sandwiching graphene or graphene composite as claimed in claim 2, wherein the said graphene or graphene composite is longitudinal stretched and transversely compressed through a drawing-compression device to make its structure more dense, flat, and orderly, thereby improving the integrity of the graphene.

10. The composite material of multilayer metal sandwiching graphene or graphene composite as claimed in claim 2, wherein the said graphene or graphene composite resulting from multiple rounds of filler addition, drawing-compression, or annealing, leading to diversified final products with varied electrical or physical effects.

11. A manufacturing method of composite material of multilayer metal sandwiching graphene or graphene composite, the manufacturing steps are as follows:
step (1): using a circular linear core base as an axis, the outer surface of the core base in annularly covered with a first layer filler part, the inner surface of the first layer filler part is formed with graphene or a graphene composite; such that the outer surface of the core base and
the inner surface of the first layer filler part jointly sandwich the graphene or a graphene composite; after the core base is annularly covered, the two side ends of the first layer filler part are connected by welding;
step (2): axially passing the core base and the first layer filler part through a die device, and subject them to compression and stretch processing to a predetermined outer diameter, thereby completing the first composite material product;
step (3): annularly covering the first composite material product with a second layer filler part, the inner surface of the second layer filler part is formed with graphene or a graphene composite; such that the outer surface of the first composite material product and the inner surface of the second layer filler part jointly sandwich the graphene or a graphene composite; after the first composite material product is annularly covered, connecting the two side ends of the second layer filler part by welding;
step (4): repeat step (2) to axially passing the first composite material product and the second layer filler part through the die mold device, and subject them to compression and stretch processing to a predetermined outer diameter, thereby completing the second composite material product;
repeat the above step (3) and step (4) continuously until a preset number layer of filler part is reached, and the multiple layer filler parts respectively sandwich with graphene or a graphene composite;
complete the annular coating, welding, compressing and stretching process by layer until the same or different electrical or physical properties are obtained for application.

12. The manufacturing method as claimed in claim 11, wherein the preset specifications, dimensions, processing methods, conditions, procedures, parameters, cross-sectional areas or diameters, and shrinkage ratio of the said filler parts can be predetermined according to the set target to produce a finished product that meet the required specifications and achieves the required performance and functionality.

13. The manufacturing method as claimed in claim 11, wherein the graphene or graphene composite may be graphene powder, dry powder mixture of graphene and fine metallic powder, liquid graphene suspension mixture, or solid or foil-like graphene-metal composite.

14. The manufacturing method as claimed in claim 13, wherein the graphene or graphene composite formed on the filler part prior to drawing and compression is based on various equipment operating parameters, wherein:
(1) Graphene:
Filling device: quantitative automatic feeding equipment;
Heating device: capable of removing moisture through evaporation, temperature 200° C.;
Ultrasonic (high-frequency) device: adjustable in the range of 100-1000 Hz;
(2) Dry powder mixture of graphene and fine metallic powder:
Filling device: quantitative automatic feeding equipment;
Heating device: capable of removing moisture through evaporation, temperature 200° C.;
Ultrasonic (high-frequency) device: adjustable in the range of 100-1000 Hz;
(3) Liquid graphene suspension mixture: may be in the form of coatings, inks, or pastes;
Additives may include water, alcohol, dispersants, suspensions, adhesives, or organic compounds;
Filling device: for relatively fluid mixtures, would be general spraying, electrostatic spraying, of printing, etc.; for viscous mixtures can be brushing, coating, or printing;
Heating device: heating equipment to decompose and evaporate additives, at a temperature of 500° C.-1000° C.; may optionally employ an Atmospheric Plasma Pressure Jet (APPJ);
Ultrasonic (high-frequency) device: adjustable in the range of 100-1000 Hz;
(4) Solid or foil-like graphene-metal composite: may be a graphene-copper composite, fixed onto the filler part by spot welding.

15. The manufacturing method as claimed in claim 13, wherein the graphene or graphene composite formed on the said filler part can be applied partially, longitudinally, or substantially covering the entire surface.

16. The manufacturing method as claimed in claim 11, wherein the said core base is covered and positioned by the said filler part which already bearing the graphene or graphene composite, such that after the said core base is wrapped by two or more layers of filler part, the graphene or graphene composite can be sandwiched and hold; the multiple layers of sandwiched graphene or graphene composite may be arranged at the same or different angles or relative positions, or without predetermined orientation.

17. The manufacturing method as claimed in claim 11, wherein the amount of graphene is set based on the said filler part and in the range of 0.01-0.5% wt relative to the filler part.

18. The manufacturing method as claimed in claim 11, wherein both said core base and filler part are cylindrical in shape and of unrestricted length, and the finished product may be round wires of various diameters, primarily for use as electrical conductors, or may be further processed, such as by extrusion, deformation, or cutting into different sizes or lengths to meet design requirements.
